(19) United States
(12) Patent Application Publication
(10) Pub. No.: US 2015/0069240 A1
(43) Pub. Date: Mar. 12, 2015

(54) TERAHERTZ ELECTROMAGNETIC WAVE GENERATOR, TERAHERTZ SPECTROMETER AND METHOD OF GENERATING TERAHERTZ ELECTROMAGNETIC WAVE

(71) Applicant: Panasonic Intellectual Property Management Co., Ltd., Osaka (JP)

(72) Inventors: Kohei TAKAHASHI, Osaka (JP); Tsutomu KANNO, Kyoto (JP); Akihiro SAKAI, Nara (JP); Yuka YAMADA, Nara (JP)

(21) Appl. No.: 14/539,465

(22) Filed: Nov. 12, 2014

Related U.S. Application Data
(63) Continuation of application No. PCT/JP2014/000930, filed on Feb. 21, 2014.

(30) Foreign Application Priority Data
Mar. 18, 2013 (JP) 2013-054781

(51) Int. Cl. H01S 1/00; G01N 21/59; G21K 5/02; G01N 21/3581

(52) U.S. Cl. CPC H01S 1/00; G01N 21/3581; G01N 21/59; G21K 5/02; G01N 2201/0697; G01N 2201/0612
USPC 250/338.1; 250/504 R

(57) ABSTRACT

A terahertz electromagnetic wave generator according to the present disclosure includes: a thermoelectric material layer; and a light source system which is configured to irradiate the thermoelectric material layer with pulsed light and generate a terahertz wave from the thermoelectric material layer. The thermoelectric material layer includes a gradient portion in which transmittance of the pulsed light varies in a certain direction. And the light source system is configured to irradiate the gradient portion of the thermoelectric material layer with the pulsed light.

This is a continuation of International Application No. PCT/JP2014/000930, with an international filing date of Feb. 21, 2014, which claims priority of Japanese Patent Application No. 2013-054781, filed on Mar. 18, 2013, the contents of which are hereby incorporated by reference.

### BACKGROUND

1. Technical Field

The present application relates to a terahertz electromagnetic wave generator, a terahertz spectrometer, and a method of generating a terahertz electromagnetic wave.

2. Description of the Related Art

In this specification, the “terahertz electromagnetic wave” will refer herein to an electromagnetic wave, of which the frequency falls within the range of 0.1 THz to 100 THz. 1 THz (terahertz) is 1×10¹² (=the twelfth power of 10) Hz. Terahertz electromagnetic waves are now used in various fields including security, medical treatments, and nondestructive tests on electronic parts. Since there are excitation, vibration and rotation modes of various electronic materials, organic molecules and gas molecules in the terahertz electromagnetic wave frequency range, people have proposed that a terahertz electromagnetic wave be used as a sort of “fingerprint” to recognize a given material. On top of that, since a terahertz electromagnetic wave is safer than an X ray or any of various other electromagnetic waves, the terahertz electromagnetic wave can be used to make a medical diagnosis without doing harm on the body of a human subject.

As disclosed in Nature Mater. 1, 26, (2002), a photoconductor or a nonlinear optical crystal is used as a conventional terahertz electromagnetic wave generator. In any of those elements, a terahertz electromagnetic wave is generated by irradiating the element with a laser beam, of which the pulse width falls within the range of a few femtoseconds to several hundred femtoseconds (and which will be hereinafter referred to as a “femtosecond laser beam”). 1 femtosecond is 1×10⁻¹⁵ (=the minus fifteenth power of 10) seconds. In a vacuum, an electromagnetic wave travels approximately 300 nm in one femtosecond.

Such a terahertz electromagnetic wave is generated by taking advantage of a so-called “dipole radiation” phenomenon in classical electromagnetism. That is to say, a variation in electric polarization or current in accelerated motion with time generates an electromagnetic wave at a frequency corresponding to the rate of that variation. Since a variation in polarization or current is induced in a few femtoseconds to several hundred femtoseconds (which depends on the pulse width of the laser beam) by being irradiated with a femtosecond laser beam, the electromagnetic wave generated by dipole radiation has a frequency falling within the terahertz range.

### SUMMARY

According to a method of generating a terahertz electromagnetic wave using a photoconductor, a bias voltage needs to be applied to the photoconductor. That is why to generate a terahertz electromagnetic wave, not only a femtosecond laser diode but also an external voltage supply are needed. However, to use the terahertz electromagnetic wave technologies in a broader range of fields in practice, a method of generating a terahertz electromagnetic wave without using such an external voltage supply should be provided so that the technologies work in various operating environments.

According to a method of generating a terahertz electromagnetic wave using a nonlinear optical crystal, on the other hand, no external voltage supply is needed. However, since the second-order nonlinear optical effect is used, a femtosecond laser beam needs to be radiated precisely toward a predetermined crystal orientation of a nonlinear optical crystal. In addition, the phase matching condition needs to be satisfied, and therefore, the nonlinear optical crystal should be designed, shaped and controlled precisely enough.

The present disclosure provides a technique for generating a terahertz electromagnetic wave using a simpler configuration.

In one general aspect, a terahertz electromagnetic wave generator disclosed herein includes: a thermoelectric material layer; and a light source system which is configured to irradiate the thermoelectric material layer with pulsed light and generate a terahertz wave from the thermoelectric material layer. The thermoelectric material layer includes a gradient portion in which transmittance of the pulsed light varies in a certain direction, and the light source system is configured to irradiate the gradient portion of the thermoelectric material layer with the pulsed light.

In another aspect, a terahertz spectrometer disclosed herein includes: the terahertz electromagnetic wave generator described above; an optical system which irradiates an object with a terahertz electromagnetic wave that has been generated by the terahertz electromagnetic wave generator; and a detector which detects the terahertz electromagnetic wave that has been transmitted through, or reflected from, the object.

In another aspect, a method of generating a terahertz electromagnetic wave disclosed herein includes the steps of: (A) providing a thermoelectric material body which exhibits gradient transmittance to incoming pulsed light; and (B) locally heating the thermoelectric material body by irradiating the thermoelectric material body with pulsed light. The step (B) includes the steps of: locally heating the thermoelectric material body so that an asymmetric heat distribution is formed in the thermoelectric material body; and producing thermal diffusion current in the portion of the thermoelectric material body that has been heated locally, thereby generating a terahertz electromagnetic wave.

According to the present disclosure, by irradiating a thermoelectric material layer with a femtosecond laser beam, a macroscopic current can be induced, and a terahertz electromagnetic wave can be generated from this current.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

FIG. 1A illustrates how the Seebeck effect is produced.

FIG. 1B is a perspective view illustrating a terahertz electromagnetic wave generator according to the present disclosure.

FIG. 2A is a cross-sectional view illustrating a terahertz electromagnetic wave generator according to the present disclosure.

FIG. 2B is a cross-sectional view illustrating another exemplary terahertz electromagnetic wave generator according to the present disclosure.

FIG. 2C is a cross-sectional view illustrating still another exemplary terahertz electromagnetic wave generator according to the present disclosure.

FIG. 3A is a schematic representation illustrating a terahertz electromagnetic wave generator according to the present disclosure.

FIG. 3B illustrates an exemplary configuration for a terahertz spectrometer according to an embodiment of the present disclosure.

FIG. 3C is a flowchart showing the procedure of generating a terahertz electromagnetic wave.

FIG. 4 shows a two-dimensional distribution of the transmittance of a Bi layer according to Example 1.

FIG. 5 is a graph showing the time domain waveform of a terahertz electromagnetic wave generated from the Bi layer of Example 1.

FIG. 6 is a graph showing the power spectrum of the terahertz electromagnetic waveform of Example 1 shown in FIG. 5.

FIG. 7 is a graph showing the sample rotation angle dependence of the peak intensity of the terahertz electromagnetic wave generated from the Bi layer of Example 1.

FIG. 8 is a graph showing the sample rotation angle dependence of the transmission gradient of the Bi layer of Example 1.

FIG. 9 shows a two-dimensional distribution of the transmittance of a Bi₂Te₃ layer according to Example 2.

FIG. 10 is a graph showing the time domain waveform of a terahertz electromagnetic wave generated from the Bi₂Te₃ layer of Example 2.

FIG. 11 is a graph showing the power spectrum of the terahertz electromagnetic waveform of Example 2 shown in FIG. 10.

FIG. 12 is a graph showing the sample rotation angle dependence of the peak intensity of the terahertz electromagnetic wave generated from the Bi₂Te₃ layer of Example 2.

FIG. 13 is a graph showing the sample rotation angle dependence of the transmission gradient of the Bi₂Te₃ layer of Example 2.

FIG. 14 is a graph showing the time domain waveforms of electromagnetic waves generated from two kinds of Bi layers with mutually different transmission gradients according to Comparative Example 1.

FIG. 15 is a graph showing the time domain waveforms of electromagnetic waves generated from two kinds of Bi₂Te₃ layers with mutually different transmission gradients according to Comparative Example 2.

### DETAILED DESCRIPTION

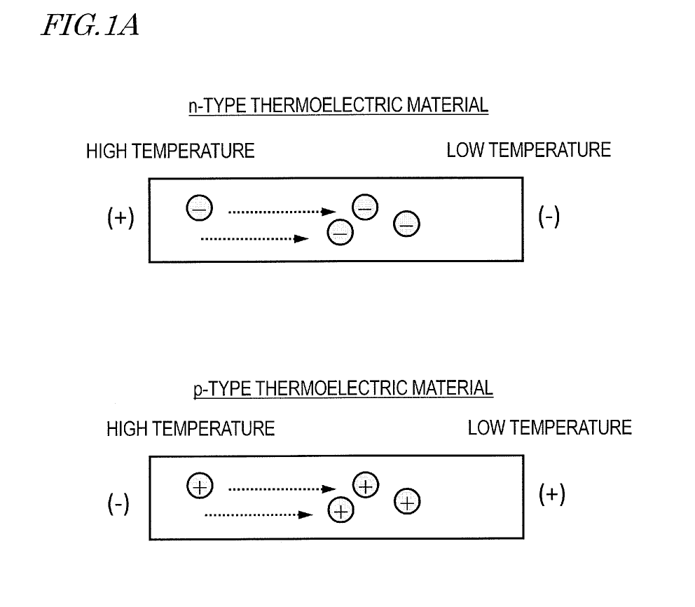

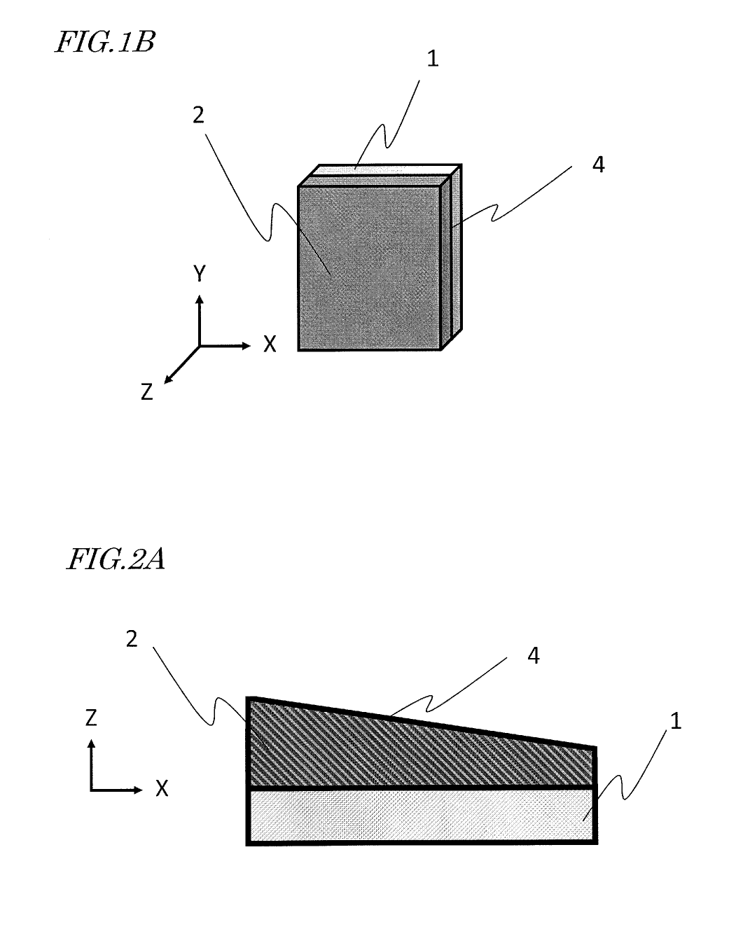

A terahertz electromagnetic wave generator according to the present disclosure uses the Seebeck effect to be expressed by a thermoelectric material. The Seebeck effect is a phenomenon that a difference in temperature in an object is directly transformed into a voltage and is a kind of a thermoelectric effect. FIG. 1A schematically illustrates how the Seebeck effect is produced. In FIG. 1A, illustrated are an n-type thermoelectric material and a p-type thermoelectric material. In each of these materials, the temperature is higher at its left end than at its right end. In this case, in the n-type thermoelectric material, electrons that are majority carriers move (i.e., diffuse thermally) from the left at a relatively high temperature to the right at a relatively low temperature, thus generating a voltage. On the other hand, in the p-type thermoelectric material, holes that are majority carriers move (i.e., diffuse thermally) from the left at a relatively high temperature to the right at a relatively low temperature, thus generating a voltage. In both of these two materials, the majority carriers move in the same direction from a portion at the higher temperature toward a portion at the lower temperature. However, the polarity of the majority carriers of the n-type thermoelectric material is opposite from that of the majority carriers of the p-type thermoelectric material, and therefore, currents flow through the materials in mutually opposite directions.

In general, a thermoelectric material is a material which generates a voltage and current by producing a temperature gradient within a substance. According to the present disclosure, a temperature gradient is introduced into a thermoelectric material with a femtosecond laser beam, thereby producing current through the thermal diffusion. And by using that current, a terahertz electromagnetic wave is generated by dipole radiation. Nevertheless, if current has been induced symmetrically in a space, it can be said that no current has been produced macroscopically, and therefore, no terahertz electromagnetic wave is generated, either. On the other hand, if asymmetric current can be induced, then the current will flow in one direction macroscopically, and a terahertz electromagnetic wave can be generated by dipole radiation.

A terahertz electromagnetic wave generator according to the present disclosure includes: a thermoelectric material layer; and a light source system which is configured to irradiate the thermoelectric material layer with pulsed light and generate a terahertz wave from the thermoelectric material layer. The thermoelectric material layer includes a gradient portion in which transmittance of the pulsed light varies in a certain direction, and the light source system is configured to irradiate the gradient portion of the thermoelectric material layer with the pulsed light.

Embodiments of the present disclosure will now be described.

### EMBODIMENTS

FIG. 1B is a perspective view illustrating a terahertz electromagnetic wave generator 4 as an embodiment of the present disclosure. As shown in FIG. 1B, the terahertz electromagnetic wave generator 4 for use in this embodiment includes a substrate 1 and a thermoelectric material layer 2 which is supported by the substrate 1. For your reference, XYZ coordinates represented by X, Y and Z axes that intersect with each other at right angles are shown in FIG. 1B. The substrate 1 illustrated in FIG. 1B has a flat plate shape. The principal surface of the substrate 1 is parallel to an XY plane and intersects with the Z axis at right angles.

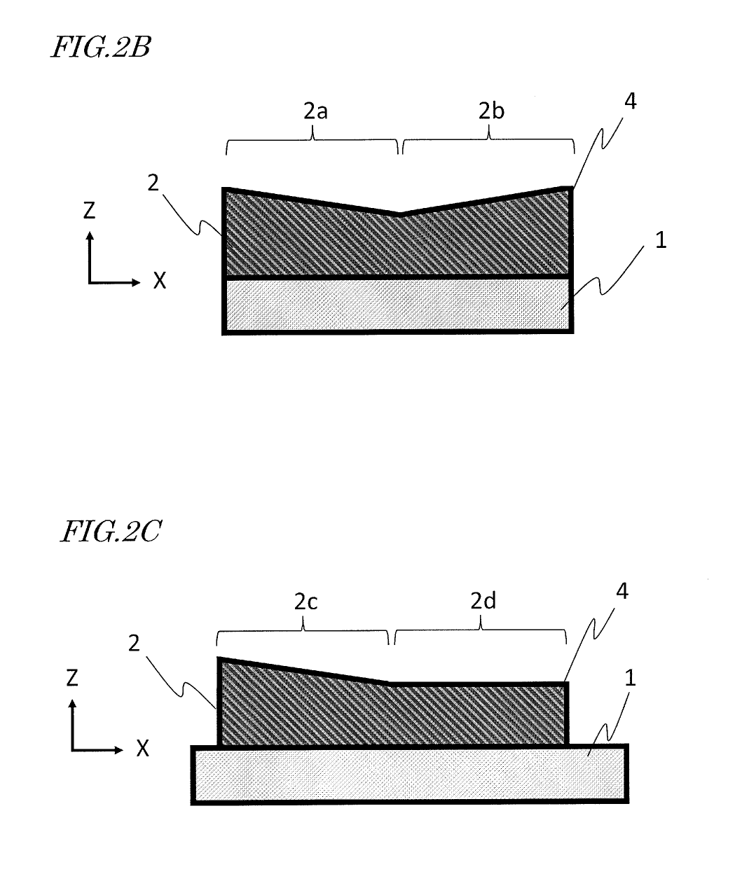

FIG. 2A schematically illustrates an exemplary cross section of the thermoelectric material layer 2 shown in FIG. 1B. This thermoelectric material layer 2 includes a gradient portion, in which the transmittance of laser light for use to generate a terahertz electromagnetic wave changes in a certain direction. In the example illustrated in FIG. 2A, the thickness of the thermoelectric material layer 2 (i.e., its size in the Z-axis direction) gradually decreases along the X axis. In this description, supposing the intensity of laser light incident on the terahertz electromagnetic wave generator 4 is S1 and the intensity of the laser light transmitted through the terahertz electromagnetic wave generator 4 is S2, the transmittance is represented herein as S2/S1. Strictly speaking, the substrate 1 may also absorb the laser light partially. But its ratio is small. Also, the laser light is absorbed into the substrate 1 uniformly within its plane. That is why the in-plane distribution of the transmittance of the thermoelectric material layer can be evaluated by S2/S1. Once an in-plane distribution of the transmittance is obtained, the transmission gradient can be obtained.

As shown in FIG. 2A, a portion of the thermoelectric material layer 2, of which the thickness changes in the in-plane direction in a broader range than the beam diameter of the laser beam, corresponds to the “gradient portion in which transmittance of the laser light changes in a certain direction”. The “gradient portion” is a portion in which the transmission gradient has a non-zero value. In the example shown in FIG. 2A, the entire thermoelectric material layer 2 is the “gradient portion”. According to the results of experiments (including the examples to be described later) and studies that the present inventors carried out, the gradient in the gradient portion of the thermoelectric material layer may fall within the range of 10%/m to 90%/m. To achieve such a gradient, the rate of variation in the thickness of the thermoelectric material layer 2 may actually be relatively small. Thus, the rate of variation in the thickness of the thermoelectric material layer 2 is exaggerated in FIG. 2A.

FIG. 2B illustrates another exemplary cross section of the thermoelectric material layer 2. In this example, the thermoelectric material layer 2 includes a first gradient portion 2a, of which the thickness gradually decreases along the X axis, and a second gradient portion 2b, of which the thickness gradually increases along the X axis. In irradiating such a thermoelectric material layer 2 with a laser beam, its beam spot should not cross the boundary between these two gradient portions where the direction of the gradient inverts.

FIG. 2C illustrates still another exemplary cross section of the thermoelectric material layer 2. In this example, the thermoelectric material layer 2 includes a gradient portion 2c, of which the thickness gradually decreases along the X axis, and a uniform portion 2d, of which the thickness is constant along the X axis. In irradiating such a thermoelectric material layer 2 with a laser beam, its beam spot should not cross the boundary between these two portions where the direction of the gradient changes.

As can be seen from these examples, the thermoelectric material layer 2 does not have to have a thickness that decreases monotonically in one direction over the entire plane, but may include a portion of which the thickness decreases in that direction, a portion of which the thickness increases, and a portion of which the thickness is constant.

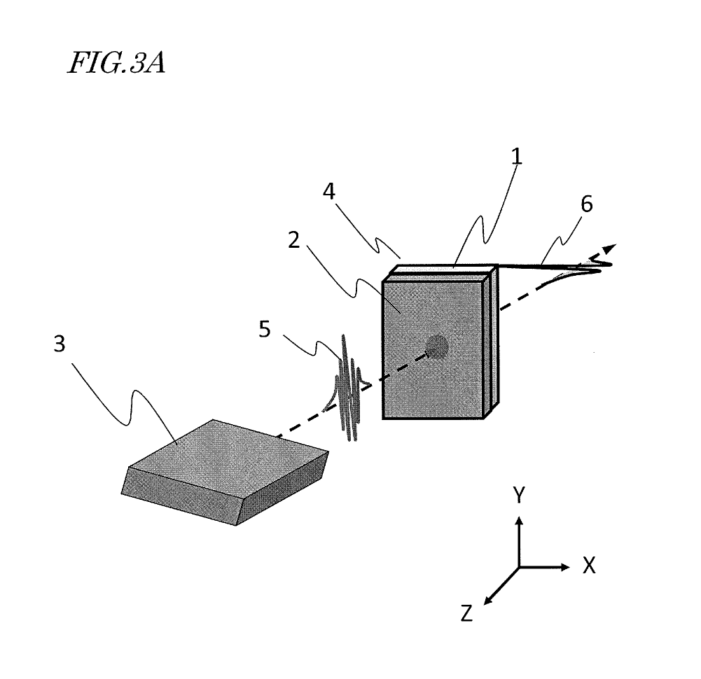

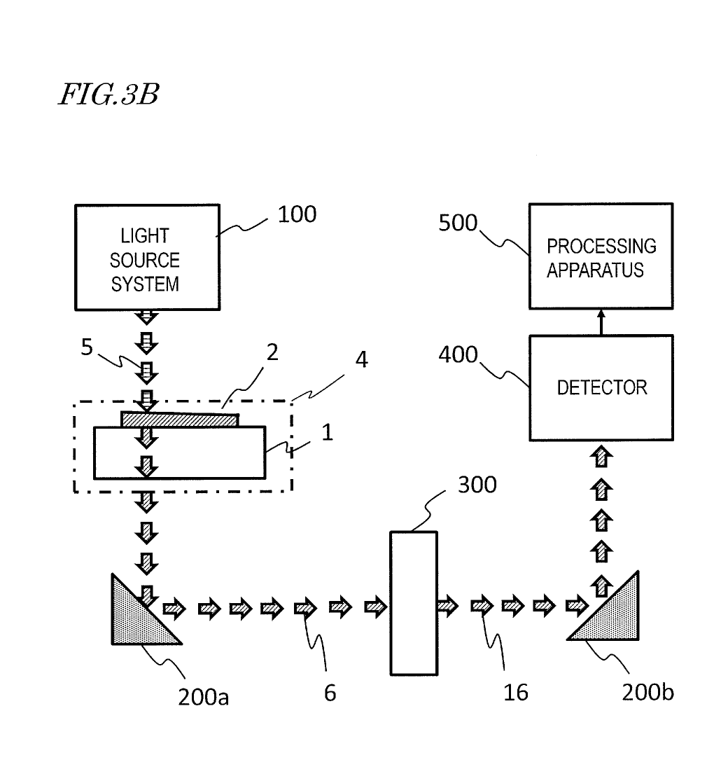

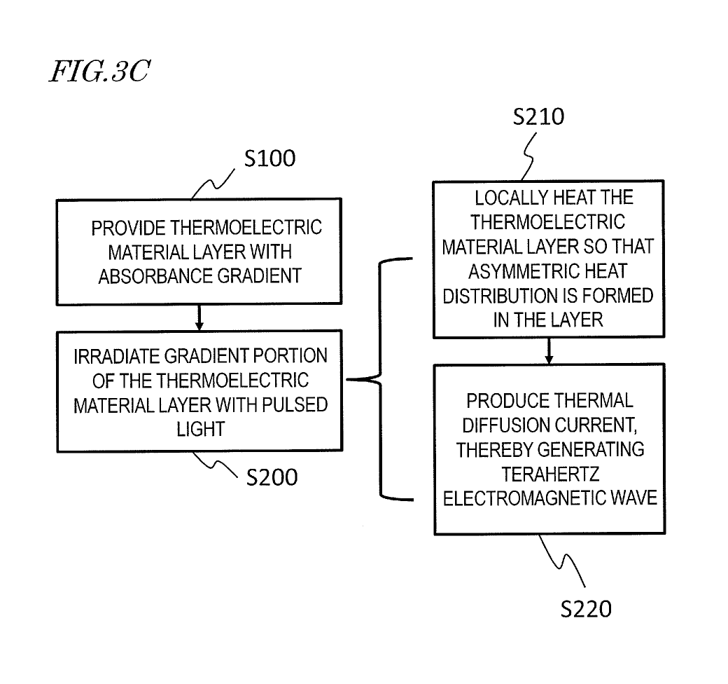

FIG. 3A is a perspective view schematically illustrating an exemplary configuration for a terahertz electromagnetic wave generator according to an embodiment of the present disclosure. As shown in FIG. 3A, the terahertz electromagnetic wave generator of this embodiment includes a femtosecond laser light source 3 and a terahertz electromagnetic wave generator 4, which includes the thermoelectric material layer 2 supported by the substrate 1 as described above. The femtosecond laser light source 3 of this embodiment irradiates a gradient portion of the thermoelectric material layer 2 of the terahertz electromagnetic wave generator 4 with a pulsed femtosecond laser beam 5. As described above, the gradient portion is a portion of which the transmittance changes in a certain direction.

The femtosecond laser beam may have a pulse width of 1 femtosecond to 1 nanosecond, and typically has a pulse width falling within the range of 10 femtoseconds to 100 femtoseconds. Such a pulsed femtosecond laser beam can be radiated 1 to 10⁸ times per second. In the thermoelectric material layer 2 irradiated with such a pulsed femtosecond laser beam 5, the temperature rises in a short time (which is approximately as long as a laser beam radiation time) and current is produced in the gradient portion of the thermoelectric material layer 2 due to thermal diffusion involved with the Seebeck effect. In this case, in the gradient portion irradiated with the laser beam, the transmittance changes in one direction and its in-plane distribution is asymmetric. That is why as the laser beam is absorbed, the temperature will also rise asymmetrically. As a result, the carriers will also diffuse asymmetrically due to the Seebeck effect. Consequently, current will flow in the direction in which the transmittance changes, macroscopically speaking. And a terahertz electromagnetic wave 6 is generated from such a current as its source.

According to this embodiment, if the spot radius of the femtosecond laser beam 5 is r, the radiation position of the femtosecond laser beam is adjusted so that the gradient portion is located within the distance r from the center of the laser beam, and the gradient portion of the thermoelectric material layer 2 is selectively heated by being irradiated with a pulsed laser beam.

The spot radius r of the femtosecond laser beam 5 is defined to be the radius of an area where the beam intensity becomes equal to or greater than l/e of the beam center intensity, where e is the base of natural logarithms and is represented by an approximate value of 2.7. In this embodiment, if the spot radius r of the femtosecond laser beam 5 were too small, the temperature gradient would be produced in a narrower area. Thus, to form a temperature gradient in a sufficiently broad area, the spot radius r of the femtosecond laser beam 5 is typically set to fall within the range of 10 μm to 20 mm.

Also, the femtosecond laser beam raises the temperature of the thermoelectric material layer 2 with pulses, and therefore, the wavelength of the laser beam is set to be a value falling within the range in which the laser beam is absorbed into the thermoelectric material layer 2. The wavelength range in which the laser beam is absorbed into the thermoelectric material layer 2 may vary according to the type of the thermoelectric material that forms the thermoelectric material layer 2.

In the terahertz electromagnetic wave generator of the present disclosure, the thermally diffused current produced by the Seebeck effect becomes the source of a terahertz electromagnetic wave, and therefore, it does not matter whether the material of the thermoelectric material layer 2 is an n-type material or a p-type one. The thermoelectric material layer 2 may be made of a material with a large Seebeck coefficient and a high degree of electrical conductivity. Examples of thermoelectric materials which may be used to make the thermoelectric material layer 2 include single-element thermoelectric materials such as Bi and Sb, alloy-based thermoelectric materials such as BiTe, PbTe and SiGe based materials, and oxide-based thermoelectric materials such as CaₓCoO₂, NaₓCoO₂, and SrTiO₃. In this description, the “thermoelectric material” refers herein to a material with a Seebeck coefficient, of which the absolute value is equal to or greater than 30 μV/K, and an electrical resistivity of 10 m Ω cm or less. Such a thermoelectric material may be either crystalline or amorphous.

The substrate 1 of this embodiment is made of a material which can transmit the terahertz electromagnetic wave generated and may be made of a dielectric material, for example. Examples of dielectric materials which may be used to make the substrate 1 include SiO₂, Al₂O₃, MgO, Si and LSAT. Not the entire substrate 1 has to be made of the same material, and the substrate 1 does not have to have a uniform thickness, either. The principal surface of the substrate 1 is typically flat but may have some unevenness, too. The function to be performed by the substrate 1 is to support the thermoelectric material layer 2. As long as the substrate 1 can perform this function, the substrate 1 may have any of various forms.

In the terahertz electromagnetic wave generator 4 of the present disclosure, the thermoelectric material layer 2 may have a thickness at which 50% or more of the terahertz electromagnetic wave generated can be transmitted. In the area where the terahertz electromagnetic wave is generated, the thickness of the thermoelectric material layer 2 may be set to fall within the range of 10 nm to 1000 nm (=1 μm), for example. The thermoelectric material layer 2 may be formed by any method, which may be a sputtering process, an evaporation process, a laser ablation process, a vapor deposition process such as chemical vapor deposition, a liquid phase deposition process, or any of various other methods. The thermoelectric material layer 2 does not have to be deposited directly on the principal surface of the substrate 1. Alternatively, the thermoelectric material layer 2 may be deposited on another substrate and then transferred onto the principal surface of the substrate 1.

FIG. 3B illustrates an exemplary configuration for a terahertz spectrometer according to an embodiment of the present disclosure. This spectrometer includes a light source system 100 which emits the femtosecond laser beam 5, the terahertz electromagnetic wave generator 4 of the present disclosure, an optical system (including mirrors 200a and 200b) which irradiates an object (sample 300) with the terahertz electromagnetic wave 6 generated by the terahertz electromagnetic wave generator 4, and a detector 400 which detects the terahertz electromagnetic wave 16 that has been transmitted through the sample 300. Optionally, this terahertz spectrometer may further include a processing apparatus 500 which generates an image representing a terahertz electromagnetic wave with a particular wavelength based on the output of the detector 400.

As shown in FIG. 3C, a method of generating a terahertz electromagnetic wave according to the present disclosure includes the step S100 of providing a thermoelectric material body which exhibits gradient absorbance to incoming pulsed light (e.g., the femtosecond laser beam), and the step S200 of irradiating the thermoelectric material layer with pulsed light. This step S200 includes the step S210 of locally heating the gradient portion of the thermoelectric material body so that an asymmetric heat distribution is formed in the thermoelectric material body, and the step S220 of producing thermal diffusion current in the portion of the thermoelectric material body that has been heated locally, thereby generating a terahertz electromagnetic wave.

The thermoelectric material layer 2 does not have to have such a shape of a single film that covers the surface of the substrate. Alternatively, the thermoelectric material layer 2 may also be patterned by a known method to have any other shape. For example, the thermoelectric material layer 2 may have a linear pattern, a bent curved pattern or a curvilinear pattern or may also have a single or a plurality of holes. The thermoelectric material layer 2 may be divided into a plurality of portions on the single substrate 1 or may cover the principal surface of the substrate 1 entirely. Optionally, the thermoelectric material layer 2 may be partially extended out of the principal surface of the substrate 1. The thermoelectric material layer 2 may also be a nanowire layer. The surface of the thermoelectric material layer 2 does not have to be flat and its thickness does not have to be uniform within the plane, either.

The following are some specific examples of the present disclosure.

### Example 1

An element which used n-type Bi as a thermoelectric material and SiO₂ as a substrate material, respectively, was fabricated by the following method.

First of all, a Bi layer was deposited by evaporation process to an average thickness of 50 nm on an SiO₂ substrate (10 mm×10 mm×0.5 mm). To cause a variation in a predetermined direction in the in-plane distribution of the transmittance of the Bi layer, the SiO₂ substrate was arranged in the film deposition chamber so that the thickness of the Bi layer would change in one direction. The evaporation process was carried out without heating the SiO₂ substrate after the film deposition chamber had been evacuated to a pressure of 1.0×10⁻³ Pa or less. Bi had a Seebeck coefficient of −75 μV/K and an electrical resistivity of 0.1 mΩcm.

As a femtosecond laser light source, a Ti:Sapphire laser diode with a wavelength of 800 nm, a pulse width of 100 fs and a pulse rate of 80 MHz was used.

The terahertz electromagnetic wave generator thus fabricated was scanned with a femtosecond laser beam to measure an in-plane distribution of the transmittance. FIG. 4 shows the in-plane distribution of the transmittance of the Bi layer. As can be seen from FIG. 4, the transmittance decreased monotonically from the lower left corner toward the upper right corner and a gradient was produced in the transmittance in a predetermined direction. That is to say, this result suggests that the thickness of the thermoelectric material layer changed in the predetermined direction as shown in FIG. 2A.

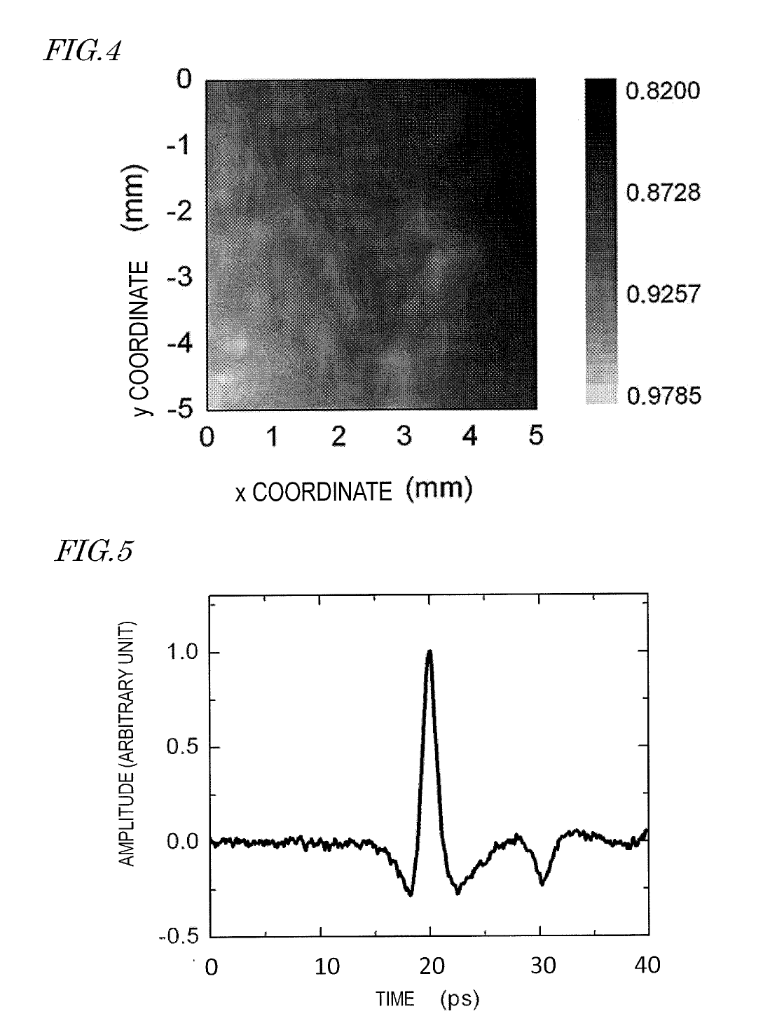

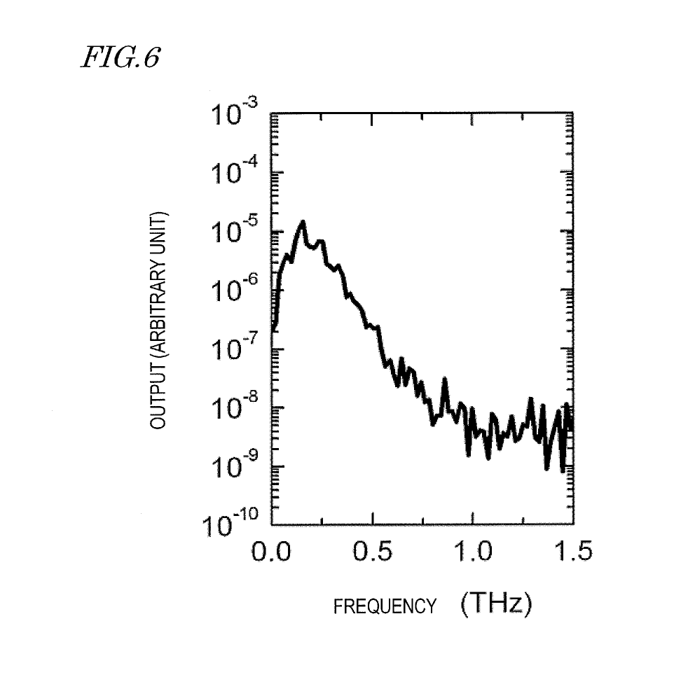

The terahertz electromagnetic wave generator thus fabricated was irradiated with a femtosecond laser beam that had been condensed to 2 mm (=2r). The time domain waveform of the electromagnetic wave measured in such a situation is shown in FIG. 5. As can be seen from the time domain waveform of the electromagnetic wave, a pulse wave with a peak intensity was generated at around 20 ps (picoseconds). FIG. 6 shows a power spectrum obtained by subjecting this time domain waveform to a Fourier transform. The electromagnetic wave generated had a frequency range of about 0.1 THz to about 1 THz. Thus, it was confirmed that a terahertz electromagnetic wave had been actually generated.

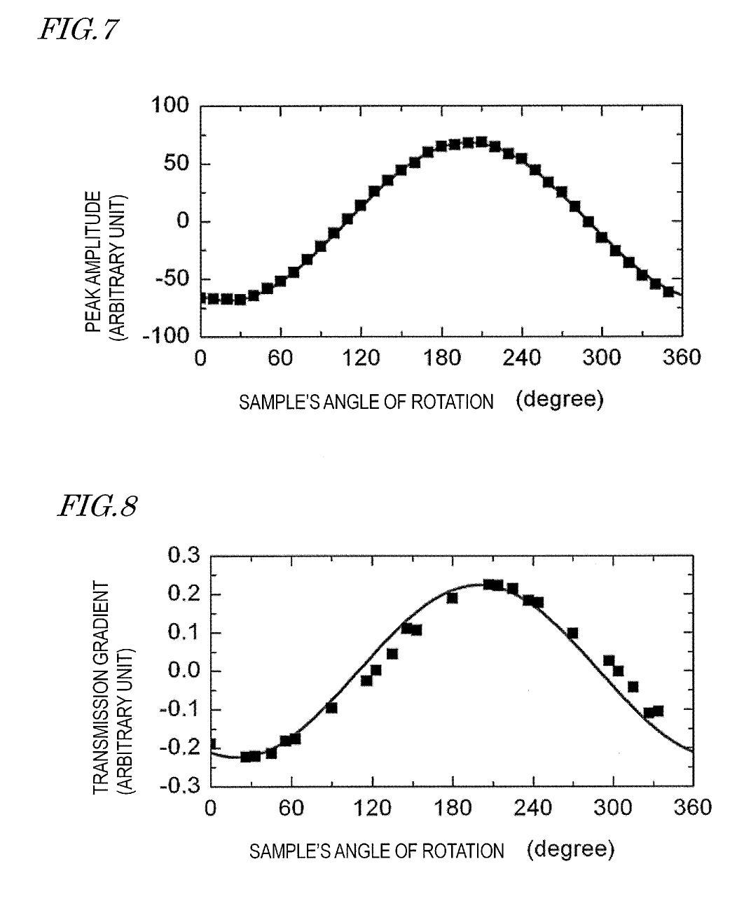

Next, the present inventors saw how the peak intensity varied if the terahertz electromagnetic wave generator was rotated within a plane of the Bi layer with the polarization of the terahertz electromagnetic wave detected fixed. As a result, the peak intensity of the terahertz electromagnetic wave drew a sine curve, of which the positive maximum value was reached at an angle of rotation of 200 degrees as shown in FIG. 7. The present inventors also saw how the transmission gradient varied if the terahertz electromagnetic wave generator was rotated within a plane of the Bi layer. As a result, the transmission gradient drew a sine curve, of which the positive maximum value was reached at an angle of rotation of 160 degrees as shown in FIG. 8. Comparing the results shown in FIGS. 7 and 8 to each other, it can be seen that the peak intensity of the terahertz electromagnetic wave and the transmission gradient drew sine curves of the same phase. These results reveal that the polarization of the terahertz electromagnetic wave agreed with the transmission gradient direction. That is to say, it means that there should be correlation between generation of an terahertz electromagnetic wave and the transmission gradient.

### Example 2

An element which used p-type Bi₂Te₃ as a thermoelectric material and MgO as a substrate material, respectively, was fabricated by the following method.

A Bi₂Te₃ layer was deposited by evaporation process to an average thickness of 50 nm on an MgO substrate (10 mm×10 mm×0.5 mm). To cause a variation in a predetermined direction in the in-plane distribution of the transmittance of the Bi₂Te₃ layer, the MgO substrate was arranged obliquely in the film deposition chamber so that the thickness of the Bi₂Te₃ layer would change in one direction. The evaporation process was carried out without heating the MgO substrate after the film deposition chamber had been evacuated to a pressure of 1.0×10⁻³ Pa or less. Bi₂Te₃ had a Seebeck coefficient of +210 μV/K and an electrical resistivity of 1 m Ωcm.

As a femtosecond laser light source, a Ti:Sapphire laser diode with a wavelength of 800 nm, a pulse width of 100 fs and a pulse rate of 80 MHz was used.

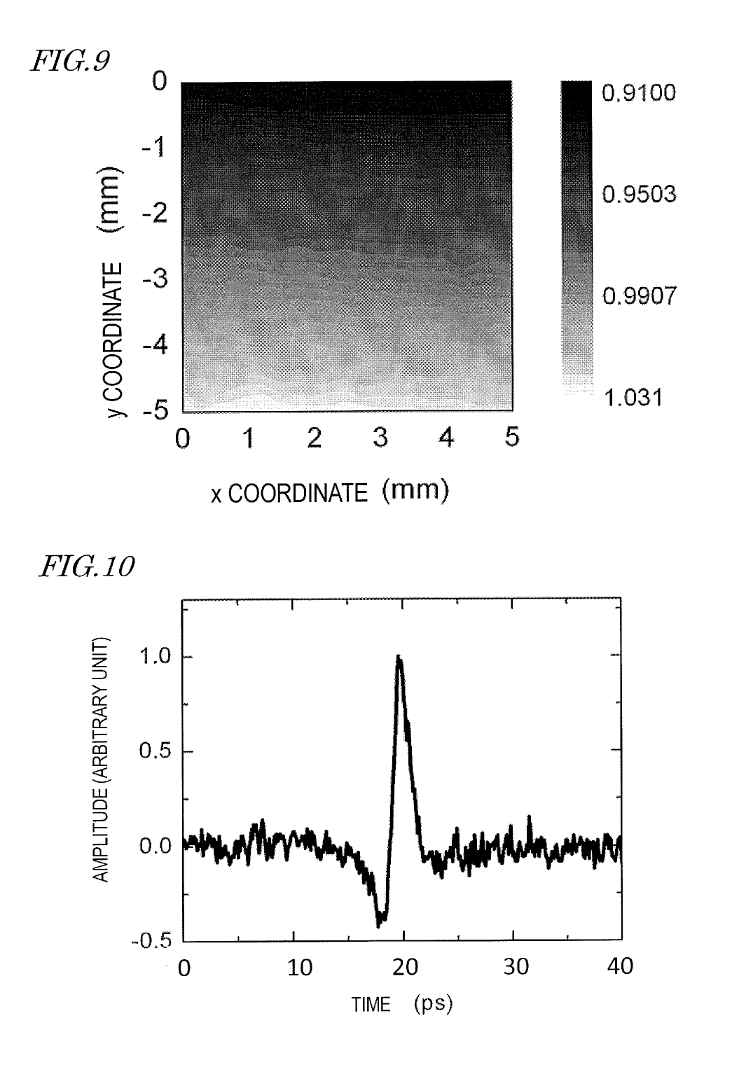

The terahertz electromagnetic wave generator thus fabricated was scanned with a femtosecond laser beam to measure an in-plane distribution of the transmittance. FIG. 9 shows the in-plane distribution of the transmittance of the Bi₂Te₃ layer. As can be seen from FIG. 9, the transmittance increased monotonically from the bottom toward the top and a gradient was produced in the transmittance in a predetermined direction. That is to say, this result suggests that the thickness of the thermoelectric material layer changed in the predetermined direction as shown in FIG. 2A.

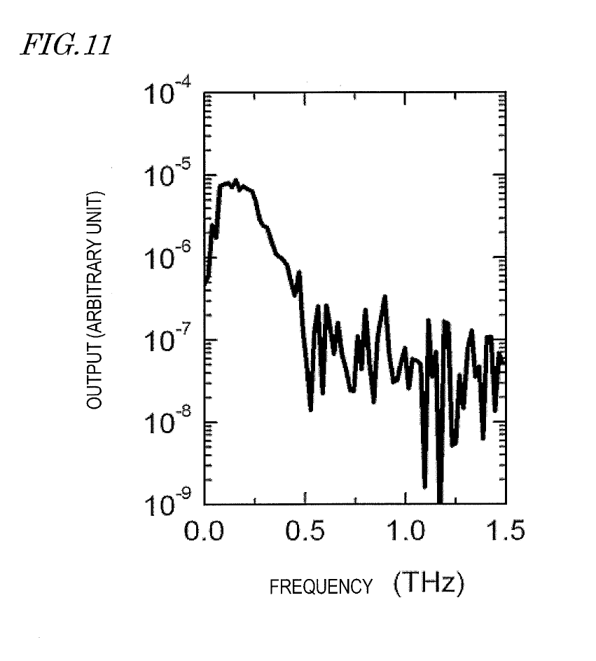

The terahertz electromagnetic wave generator thus fabricated was irradiated with a femtosecond laser beam that had been condensed to 2 mm (=2r). The time domain waveform of the electromagnetic wave measured in such a situation is shown in FIG. 10. As can be seen from the time domain waveform of the electromagnetic wave, a pulse wave with a peak intensity was generated at around 20 ps. FIG. 11 shows a power spectrum obtained by subjecting this time domain waveform to a Fourier transform. The electromagnetic wave generated had a frequency range of about 0.1 THz to about 1 THz. Thus, it was confirmed that a terahertz electromagnetic wave had been actually generated.

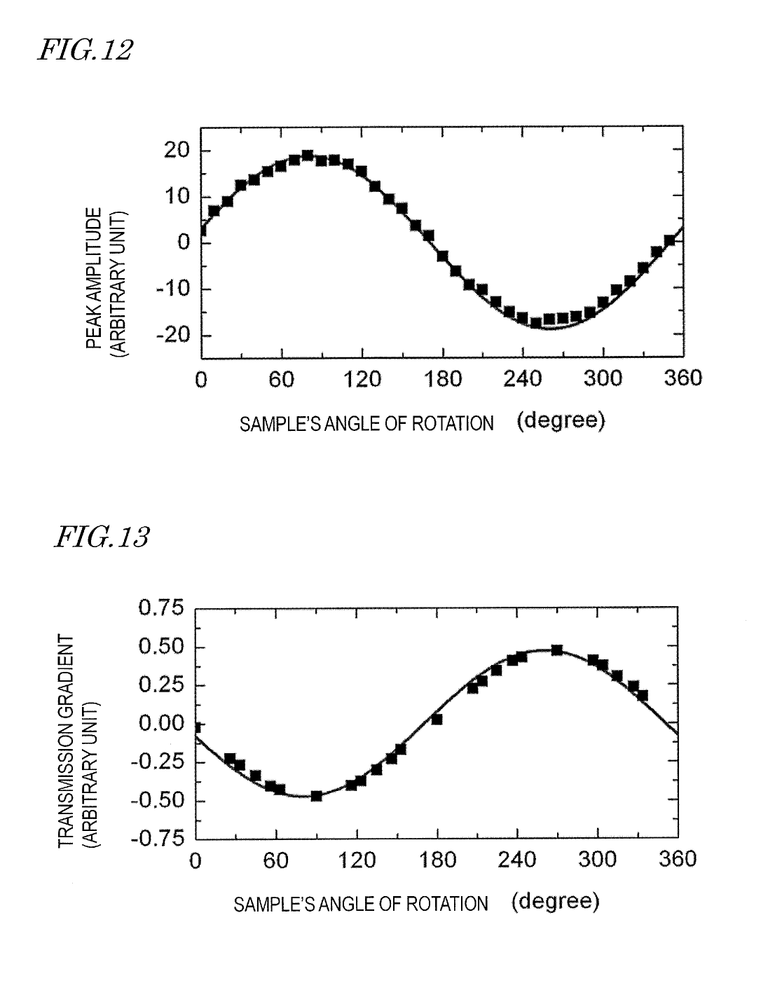

Next, the present inventors saw how the peak intensity varied if the terahertz electromagnetic wave generator was rotated within a plane of the Bi₂Te₃ layer with the polarization of the terahertz electromagnetic wave detected fixed. As a result, the peak intensity of the terahertz electromagnetic wave drew a sine curve, of which the negative minimum value (local minimum value) was reached at an angle of rotation of 260 degrees as shown in FIG. 12. The present inventors also saw how the transmission gradient varied if the terahertz electromagnetic wave generator was rotated within a plane of the Bi₂Te₃ layer. As a result, the transmission gradient drew a sine curve, of which the positive maximum value was reached at an angle of rotation of 260 degrees as shown in FIG. 13. Comparing the results shown in FIGS. 12 and 13 to each other, it can be seen that the peak intensity of the terahertz electromagnetic wave and the transmission gradient drew sine curves, of which the phases were inverse of each other (i.e., of which the phase difference was 180 degrees). These results reveal that the polarization of the terahertz electromagnetic wave agreed with the transmission gradient direction. That is to say, it means that there should be correlation between the mechanism of generating a terahertz electromagnetic wave and the transmission gradient.

Comparing the results obtained in these Examples 1 and 2 to each other, it can be seen that although the element was irradiated with a laser beam with the same experimental arrangement adopted in both of those examples, the polarity at the peak of the terahertz electromagnetic wave (i.e., whether the peak is positive or negative) inverted depending on whether the thermoelectric material used was n-type Bi or p-type Bi₂Te₃. That is to say, the sine curve phase of the sample rotation angle dependence of the terahertz electromagnetic wave peak intensity (see FIGS. 7 and 12) was inverse of (i.e., different by just 180 degrees from) that of the sample rotation angle dependence of the transmission gradient (see FIGS. 8 and 13). These results reveal that the phase of the terahertz electromagnetic wave generated by the terahertz electromagnetic wave generator of the present disclosure reflects the type of the carriers (i.e., whether they are electrons or holes) in the thermoelectric material layer.

The terahertz electromagnetic wave radiation properties of the Bi and Bi₂Te₃ layer based elements that have been described for Examples 1 and 2 exhibited no dependence on the polarization of the femtosecond laser beam. This indicates that the terahertz electromagnetic wave generating mechanism is not a secondary nonlinear effect. As for semiconductors and insulators, on the other hand, a so-called “photo-Dember effect” that is a terahertz electromagnetic wave generating mechanism which has something to do with diffusion of photo-excited carriers has also been reported. However, the polarity of a terahertz electromagnetic wave generated under the photo-Dember effect does not depend on the type of the majority carriers (i.e., whether the majority carriers are electrons or holes) (see Physical Review B73, 155330, (2006)), which is different from the terahertz electromagnetic wave radiation properties of Examples 1 and 2. Consequently, the terahertz electromagnetic wave generating mechanism of the present disclosure does not result from the photo-Dember effect.

As can be seen from the foregoing description, a method of generating a terahertz electromagnetic wave according to the present disclosure is based on a novel mechanism, and the present disclosure provides a simple terahertz electromagnetic wave source which needs no external voltage supply.

### Comparative Example 1

A Bi layer was deposited in the same way as in Example 1 to an average thickness of 50 nm on an SiO₂ substrate (10 mm×10 mm×0.5 mm). In this example, two kinds of Bi layers with mutually different thickness gradient in-plane directions were formed by changing the arrangement of the SiO₂ substrate in the film deposition chamber.

As a femtosecond laser light source, a Ti:Sapphire laser diode with a wavelength of 800 nm, a pulse width of 100 fs and a pulse rate of 80 MHz was used.

Each of these Bi layers was scanned with a femtosecond laser beam to measure its transmission gradient. As a result, one of the two Bi layers had a maximum transmission gradient of 5%/m, while the other Bi layer had a maximum transmission gradient of 22%/m.

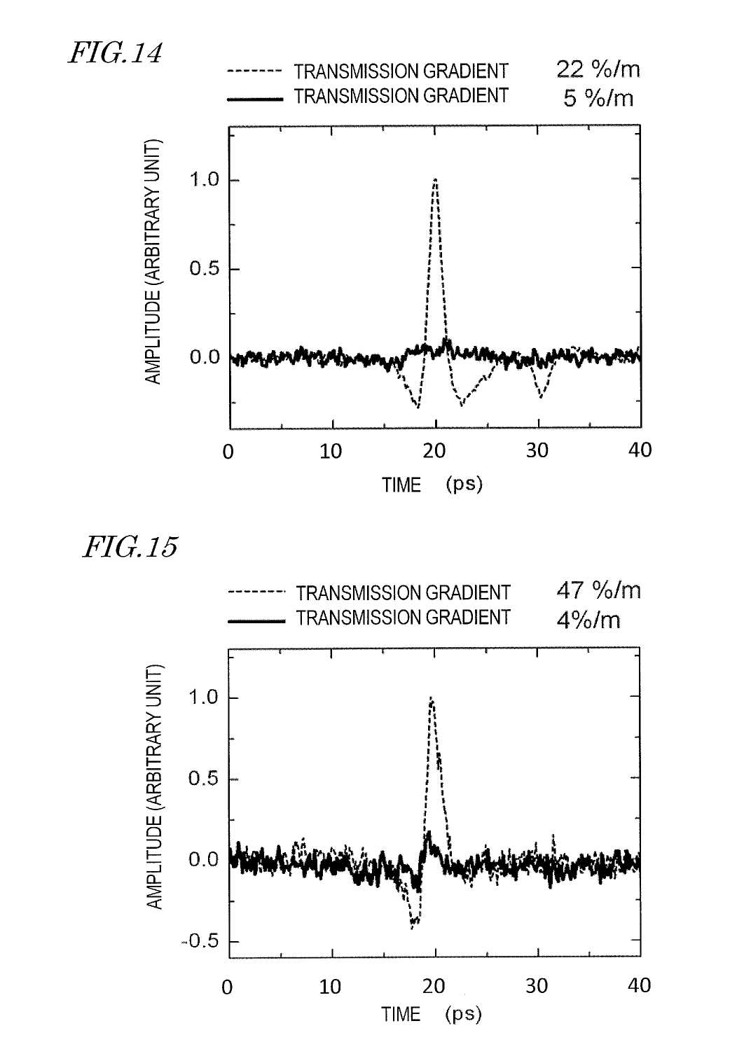

The time domain waveforms of the electromagnetic waves measured by irradiating these two kinds of Bi layers with a femtosecond laser beam that had been condensed to 2 mm (=2r) are shown in FIG. 14. As can be seen from FIG. 14, a terahertz electromagnetic wave pulse was definitely observed in the Bi layer with the steeper transmission gradient, but there was almost nothing but noise with no definite peaks observed, and no terahertz electromagnetic wave had been generated, in the Bi layer with the less steep transmission gradient.

These results reveal that by causing a variation in transmittance in a predetermined direction to the thermoelectric material layer, the element should function as a terahertz electromagnetic wave generator.

### Comparative Example 2

A Bi₂Te₃ layer was deposited in the same way as in Example 2 to an average thickness of 50 nm on an MgO substrate (10 mm×10 mm×0.5 mm). In this example, two kinds of Bi₂Te₃ layers with mutually different thickness gradients were formed by changing the arrangement of the MgO substrate in the film deposition chamber.

As a femtosecond laser light source, a Ti:Sapphire laser diode with a wavelength of 800 nm, a pulse width of 100 fs and a pulse rate of 80 MHz was used.

Each of these Bi₂Te₃ layers was scanned with a femtosecond laser beam to measure its transmission gradient. As a result, one of the two Bi₂Te₃ layers had a maximum transmission gradient of 4%/m, while the other Bi₂Te₃ layer had a maximum transmission gradient of 47%/m.

The time domain waveforms of the electromagnetic waves measured by irradiating these two kinds of Bi₂Te₃ layers with a femtosecond laser beam that had been condensed to 2 mm (=2r) are shown in FIG. 15. As can be seen from FIG. 15, a terahertz electromagnetic wave pulse was definitely observed in the Bi₂Te₃ layer with the steeper transmission gradient, but there was almost nothing but noise with no definite peaks observed, and no terahertz electromagnetic wave had been generated, in the Bi₂Te₃ layer with the less steep transmission gradient. These results reveal that by causing a variation in transmittance in a predetermined direction to the thermoelectric material layer, the element should function as a terahertz electromagnetic wave generator.

In the examples described above, the average thickness of the thermoelectric material layer is set to be 50 nm to make the comparison easily. However, it would be obvious to those skilled in the art from the entire disclosure of the present application that even if the thickness of the thermoelectric material layer is not 50 nm but falls within the range of 10 nm to 1000 nm (=1 μm), for example, similar effects will also be achieved.

Furthermore, as can be seen easily from the principle of generating a terahertz electromagnetic wave that has already been described in the foregoing description of the present disclosure, respective materials for the thermoelectric material layer and substrate according to the present disclosure do not have to be the ones used in the examples described above, but any of a wide variety of thermoelectric materials and substrate materials may be used in an arbitrary combination.

Furthermore, the transmission gradient does not always have to be produced in a predetermined in-plane direction in the thermoelectric material layer by the method adopted in the foregoing description of examples. Alternatively, a light transmitting film, of which the optical transmittance changes in a predetermined in-plane direction, may be deposited on the thermoelectric material layer. Likewise, the method of producing a gradient in the thickness of the thermoelectric material layer adopted in the examples described above is just an example, too. Alternatively, a thermoelectric material may be deposited to a uniform thickness on the substrate and then a gradient may be produced in the thickness of the thermoelectric material layer by etching, polishing or any other suitable technique.

With the technique of generating a terahertz electromagnetic wave according to the present disclosure, a terahertz electromagnetic wave can be generated by using a simpler configuration than conventional ones without providing any external voltage supply. Thus, the present disclosure is applicable to not only evaluation of the properties of various kinds of materials, but also security, healthcare and numerous other fields, using a terahertz electromagnetic wave.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. A terahertz electromagnetic wave generator comprising:
a thermoelectric material layer; and
a light source system configured to irradiate the thermoelectric material layer with pulsed light and generate a terahertz wave from the thermoelectric material layer,
the thermoelectric material layer comprising a gradient portion in which transmittance of the pulsed light varies in a certain direction, and
the light source system being configured to irradiate the gradient portion of the thermoelectric material layer with the pulsed light.

2. The terahertz electromagnetic wave generator of claim 1, wherein the terahertz electromagnetic wave has a frequency falling within the range of 0.1 THz to 100 THz.

3. The terahertz electromagnetic wave generator of claim 2, wherein the light source system includes:
a light source which emits the pulsed light, of which the pulse width falls within the range of 1 femtosecond to 1 nanosecond; and
an optical system which guides the pulsed light that has been emitted from the light source toward the gradient portion of the thermoelectric material layer.

4. The terahertz electromagnetic wave generator of claim 3, wherein the light source is a femtosecond laser light source.

5. The terahertz electromagnetic wave generator of claim 1, wherein the thermoelectric material layer is made of a material selected from the group consisting of a single-element thermoelectric material, an alloy-based thermoelectric material, and an oxide-based thermoelectric material.

6. The terahertz electromagnetic wave generator of claim 5, wherein the thermoelectric material layer is made of at least one material selected from the group consisting of Bi, Sb, a BiTe-based alloy, a PbTe-based alloy, an SiGe-based alloy, CaₓCoO₂, NaₓCoO₂, and SrTiO₃.

7. The terahertz electromagnetic wave generator of claim 1, wherein the thermoelectric material layer has a thickness of 10 nm to 1 μm.

8. The terahertz electromagnetic wave generator of claim 1, wherein in the gradient portion of the thermoelectric material layer, the gradient of its transmittance falls within the range of 10%/m to 90%/m.

9. The terahertz electromagnetic wave generator of claim 1, wherein the substrate is configured to transmit the terahertz wave.

10. A terahertz spectrometer comprising:
the terahertz electromagnetic wave generator of claim 1;
an optical system configured to irradiates an object with a terahertz electromagnetic wave that has been generated by the terahertz electromagnetic wave generator; and
a detector configured to detect the terahertz electromagnetic wave that is transmitted through, or reflected from, the object.

11. The terahertz spectrometer of claim 10, further comprising a processing apparatus which generates an image representing a terahertz electromagnetic wave with a particular wavelength based on the output of the detector.

12. A method of generating a terahertz electromagnetic wave, the method comprising the steps of:
(A) providing a thermoelectric material body which exhibits gradient transmittance to incoming pulsed light; and
(B) locally heating the thermoelectric material body by irradiating the thermoelectric material body with pulsed light,
the step (B) comprising:
locally heating the thermoelectric material body so that an asymmetric heat distribution is formed in the thermoelectric material body; and
producing thermal diffusion current in the portion of the thermoelectric material body that has been heated locally, thereby generating a terahertz electromagnetic wave.
